(19) United States
(12) Patent Application Publication
(10) Pub. No.: US 2023/0038988 A1
(43) Pub. Date: Feb. 9, 2023

(54) METHODS AND SYSTEMS FOR WORKSTREAM INTEGRATION

(71) Applicant: Workstream Analytics, Inc, New York, NY (US)

(72) Inventors: Nicholas Gray Freund, New York, NY (US); Christopher Todd Ibarra, Atlanta, GA (US); Deanna Michelle Bonds, Cullman, AL (US)

(21) Appl. No.: 17/881,199

(22) Filed: Aug. 4, 2022

Related U.S. Application Data
(60) Provisional application No. 63/229,378, filed on Aug. 4, 2021.

(51) Int. Cl. G06F 16/957; G06F 16/955

(52) U.S. Cl. CPC G06F 16/9574; G06F 16/9577; G06F 16/955

(57) ABSTRACT

A method for integrating messaging content and presentation assets. The method includes identifying, via a browser extension operating within a browser application, a presentation asset being viewed within the browser application and metadata corresponding to the presentation asset, generating a data asset key based on the metadata, assigning the data asset key to an active messaging content source, querying a database to retrieve archived messaging content associated with the data asset key, and displaying, in the browser application via the browser extension, messaging content from the active messaging content source and/or the archived messaging content alongside the presentation asset.

### CROSS-REFERENCE TO RELATED APPLICATIONS

This application claims priority to and the benefit of U.S. Provisional Patent Application No. 63/229,378 titled “METHODS AND SYSTEMS FOR WORKSTREAM INTEGRATION” and filed on Aug. 4, 2021, the entire contents of which is hereby incorporated by reference herein.

### TECHNICAL FIELD

This specification relates to analytical tools and, in particular, providing analytical workstream integration.

### BACKGROUND

Analytical tools allow analytics teams and stakeholders to monitor data assets. However, it can be difficult for analytics teams to indicate to specific stakeholders which data assets are relevant to specific business cases. In some cases, analytics teams can experience difficulty in training stakeholders on how to use analytical tools and interactive data visualizations. In addition, analytics teams may struggle with streams of inbound inquiries from users, such as questions about how to use, modify, or create these analytical assets. As such, the workflow processes of analytics teams remain fragmented and inefficient.

### SUMMARY

At least one aspect of the present disclosure is directed to a method for integrating messaging content and presentation assets, the method comprising: identifying, via a browser extension operating within a browser application, a presentation asset being viewed within the browser application and metadata corresponding to the presentation asset; generating a data asset key based on the metadata; assigning the data asset key to an active messaging content source; querying a database to retrieve archived messaging content associated with the data asset key; and displaying, in the browser application via the browser extension, messaging content from the active messaging content source and/or the archived messaging content alongside the presentation asset.

In one embodiment, displaying the messaging content alongside the presentation asset includes graphically integrating the messaging content within a browser window with the presentation asset. In some embodiments, displaying the messaging content alongside the presentation asset includes automatically opening a browser window of the browser application to display the messaging content. In various embodiments, the presentation asset is displayed in a first browser window and the messaging content is displayed in a second browser window, the first and second browser windows being different browser windows of the browser application. In certain embodiments, identifying the metadata corresponding to the presentation asset includes inspecting a uniform resource locator (URL) of the presentation asset.

In some embodiments, assigning the data asset key to the active messaging content source includes generating the active messaging content source. In one embodiment, the archived messaging content includes at least one of a messaging thread associated with the presentation asset, a screenshot associated with the presentation asset, and a video message associated with the presentation asset. In certain embodiments, the presentation asset includes a visual representation of a data asset. In various embodiments, the presentation asset includes an interactive dashboard representing a data asset. In one embodiment, the method includes dynamically updating the displayed messaging content from the active messaging content source.

Another aspect of the present disclosure is directed to a system including at least one memory and at least one processing unit for executing computer-executable instructions stored in the memory. The instructions, when executed, instruct the at least one processing unit to identify, via a browser extension operating within a browser application, a presentation asset being viewed within the browser application and metadata corresponding to the presentation asset, generate a data asset key based on the metadata, assign the data asset key to an active messaging content source, query a database to retrieve archived messaging content associated with the data asset key, and display, in the browser application via the browser extension, messaging content from the active messaging content source and the archived messaging content alongside the presentation asset.

In one embodiment, displaying messaging content from the active messaging content source and the archived messaging content alongside the presentation asset includes graphically integrating the active and archived messaging content within a browser window with the presentation asset. In some embodiments, displaying the messaging content alongside the presentation asset includes automatically opening a browser window of the browser application to display the messaging content. In various embodiments, the presentation asset is displayed in a first browser window and the messaging content is displayed in a second browser window, the first and second browser windows being different browser windows of the browser application. In certain embodiments, identifying the metadata corresponding to the presentation asset includes inspecting a uniform resource locator (URL) of the presentation asset.

In some embodiments, assigning the data asset key to the active messaging content source includes generating the active messaging content source. In one embodiment, the archived messaging content includes at least one of a messaging thread associated with the presentation asset, a screenshot associated with the presentation asset, and a video message associated with the presentation asset. In certain embodiments, the presentation asset includes a visual representation of a data asset. In various embodiments, the presentation asset includes an interactive dashboard representing a data asset. In one embodiment, the instructions, when executed, instruct the at least one processing unit to dynamically update the displayed messaging content from the active messaging content source.

### BRIEF DESCRIPTION OF THE DRAWINGS

FIG. 1 illustrates a block diagram of a workstream system in accordance with aspects described herein;

FIG. 2 illustrates a flow diagram of a method for integrating analytical workstream content into analytical asset platforms in accordance with aspects described herein;

FIG. 3 illustrates a flow diagram of a method for adding a presentation asset to a workstream application in accordance with aspects described herein; and

FIG. 4 illustrates a computer system in accordance with aspects described herein.

### DETAILED DESCRIPTION

Systems and methods for providing analytical workstream integration are disclosed herein.

Analytical tools for monitoring data assets are more powerful than ever. Yet the workflow processes of analytics teams remain fragmented and inefficient. For example, it is difficult for analytics teams to indicate to specific users (e.g., stakeholders supported by the analytics team) the data assets that are relevant to specific business cases. Likewise, analytics teams may struggle to train users on how to use these assets. In some cases, analytics teams can encounter problems in communicating important contextual information to users about the data assets (e.g., how to interpret what they are seeing, how to leverage them in daily operations, use of various filters, known issues with the underlying data, etc.). In addition, analytics teams may struggle with endless streams of inbound inquiries from users, such as questions about how to use a presentation asset (e.g., a dashboard that provides an interactive visualization of a data asset) within an analytical asset platform, requests for feature changes to an existing asset, or a completely new presentation asset or set of presentation assets that need to be created.

Communication between analytics teams and users may occur using tools that are separate from the user's analytical asset platform. For example, communication may occur through a corporate intranet, a messaging platform (e.g., email, Slack, etc.), or a traditional service desk platform using screenshot links to describe a problem or provide feedback. As such, communication between users and analytics teams (or between team members) may be highly inefficient, as users switch between various platforms to communicate context, navigate requests, and retrieve supporting information.

As such, improved systems and methods for integrating analytical workstream content with presentation assets is provided herein. In at least one embodiment, an application extension is configured to integrate messaging content with presentation assets included in an analytical asset platform. In some examples, the application extension displays active messaging content and archived messaging content alongside the presentation assets.

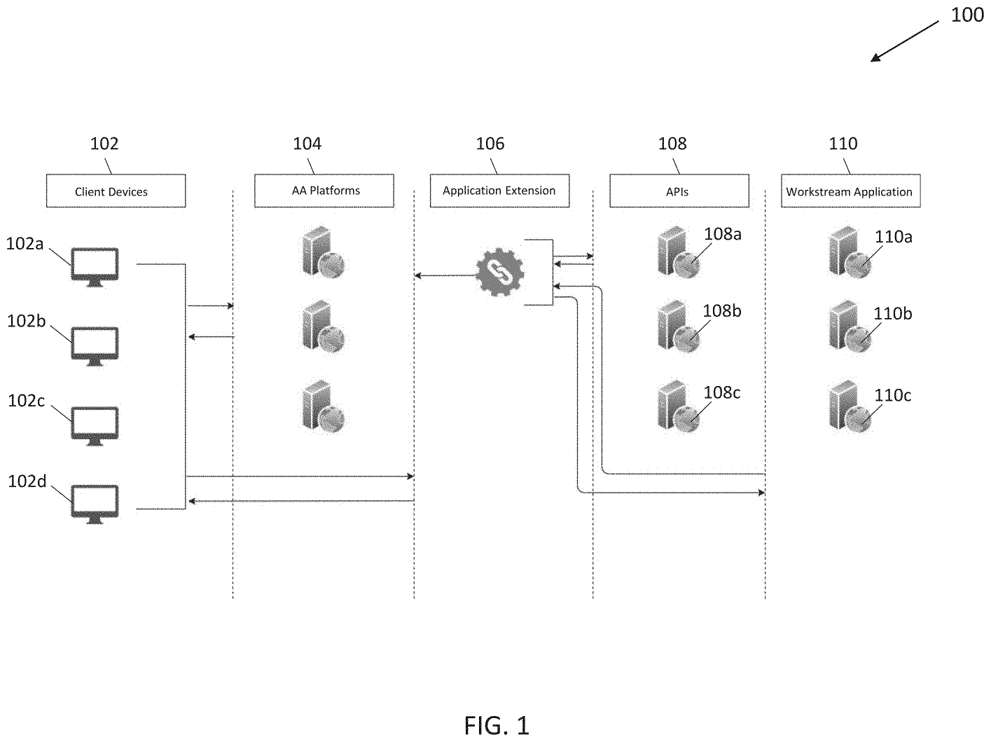

FIG. 1 is a block diagram of a workstream system 100 in accordance with aspects described herein. As shown, the workstream system 100 includes a plurality of client devices 102, a plurality of analytical asset (AA) platforms, an application extension 106, a plurality of application programming interfaces (APIs), and a plurality of workstream applications 110.

In one example, the plurality of client devices 102 includes four devices 102a-102d; however, in other examples, the plurality of client devices 102 may include any number of devices. Each client device 102 may correspond to a user. For example, the first device 102a may correspond to a first user, the second device 102b may correspond to a second user, and so on. In other examples, multiple client devices may correspond to the same user. Each client device 102 can be a personal computer, a mobile phone, a smart watch, a tablet computer, or a server. Other types of client devices are possible.

The plurality of AA platforms 104 may include one or more browser-based platforms that are accessed via a browser (e.g., an internet browser) running on the client devices 102. In one example, the plurality of AA platforms 104 includes one or more applications configured to run locally on the client devices 102. In some examples, the plurality of AA platforms 104 may include one or more self-hosted platforms (e.g., a Tableau Server). In other examples, the plurality of AA platforms 104 can include productivity solutions (e.g., Microsoft Excel, Google Sheets, Microsoft Word, Google Docs, etc.).

In some examples, the application extension 106 is a browser extension; however, in other examples, the application extension may be configured differently (e.g., as a plugin for an AA platform). The application extension 106 is configured to communicate with the client devices 102, the AA platforms 104, the APIs 108, and the workstream applications 110.

In one example, the plurality of workstream applications 110 includes three application instances 110a-110c; however, in other examples, the plurality of workstream applications 110 may include any number of application instances. Each application instance may correspond to a user. For example, the first application instance 110a may correspond to a first user, the second application instance 110b may correspond to a second user, and so on. In some examples, each application instance may have a corresponding API of the plurality of APIs 108. For example, a first API 108a may correspond to the first application instance 110a, the second API 108b may correspond to the second application instance 110b, and so on. In other examples, each API 108 may correspond to a different AA platform 104. In some examples, one or more of the plurality of workstream applications 110 are cloud-based applications hosted on one or more servers. The workstream applications 110 may include a browser-based user interface (e.g., a web app) and/or a local user interface installed on the client devices 102.

In one example, the workstream applications 110 are configured to support users (and the analytics teams) in leveraging a modern data stack. In this context, the modern data stack corresponds to a data analytics architecture that includes data pipelines feeding a cloud-based SQL warehouse, which then feeds at least one AA platform or visualization tool. In some examples, the workstream applications 110 are configured to wrap the AA platforms 104 or other visualization layers with collaboration or workflow content (e.g., messaging content, asset status, data quality). As such, primary users (e.g., analytics teams) may roll out the workstream applications 110 to various stakeholders within a business, such as sales, marketing, product, customer experience, and engineering employees. The stakeholders can engage with both the data asset (or presentation asset) content and the collaboration or workflow content natively within the workstream application 110. Likewise, the stakeholders may choose to view or engage with the data asset (or presentation content) content within the AA platforms 104. In such cases, the application extension 106 is configured to display the collaboration or workflow content alongside the data asset or presentation asset content (e.g., within the browser).

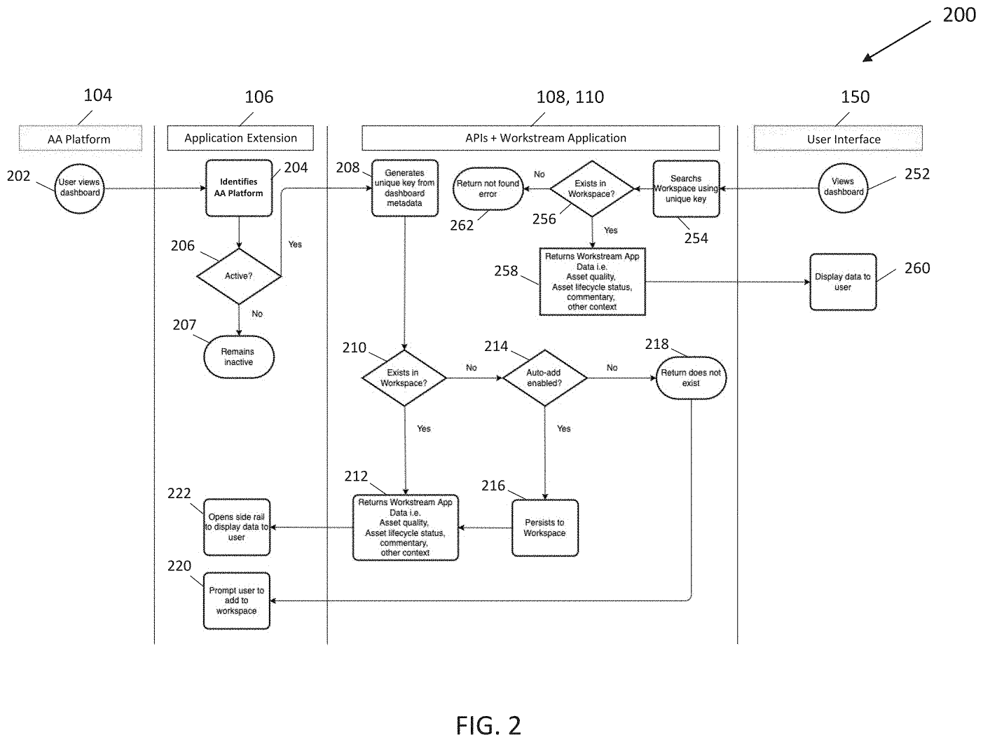

FIG. 2 is a flow diagram of a method 200 for integrating analytical workstream content into AA platforms in accordance with aspects described herein. In one example, the method 200 includes integrating analytical workstream content into a presentation asset (e.g., a dashboard) of an AA platform. In some examples, the method 200 corresponds to an operation or process carried out by the workstream system 100 of FIG. 1.

At block 202, the method 200 begins when a user (e.g., a stakeholder) views a presentation asset in an AA platform 104. At block 204, the application extension 106 identifies the AA platform 104.

At block 206, the application extension 106 determines if the AA platform 104 is active. In some examples, the AA platform 104 may be considered active if the platform is a known platform 104 supported by the workstream application 110. In response to a determination that the AA platform 104 is active, the application extension 106 provides information corresponding to the dashboard via the workstream system (e.g.., the APIs 108 and/or the workstream application 110). For example, the application extension 106 may inspect a uniform resource locator (URL) of the dashboard and provide metadata associated with the dashboard to the workstream application 110. The application extension 106 may remain inactive in response to a determination that the AA platform 104 is inactive (block 207).

At block 208, the workstream application 110 receives the information (e.g., the metadata) from the application extension 106 and generate a data asset key based on the received information. In one example, the data asset key may correspond to an embedded URL that is different from the dashboard URL.

At block 210, the workstream application 110 queries one or more databases to determine if the data asset key already exists in the user's workspace (e.g., within the workstream application 110). In some examples, the data asset key may already exist if the dashboard has been previously linked to the workstream application 110 by another user. For example, the data asset key may have been generated during a setup or configuration of the dashboard and/or the workstream application 110. In certain examples, the dashboard can be auto-imported into the workstream application 110 (e.g., via the APIs 108) and the data asset key may be generated automatically.

At block 212, if the data asset key does exist, the workstream application 110 returns application data (or content) associated with the data asset key. In some examples, the application data includes archived content. For example, the workstream application may retrieve archived messaging content including conversations (e.g., email threads, Slack messages, video conference, etc.) that occurred in the past and are relevant to the dashboard. The archived messaging content can include prior conversations held between the user and the analytics team, prior conversations held between a different user and the analytics team, and prior conversations held between different members of the analytics team. In some examples, the archived messaging content may include screenshots (or snapshots) of the dashboard from when it was previously discussed. In addition, the application content may include annotations indicating changes or updates to the dashboard, the underlying data model, or the data set. In one example, the content can include curated content provided by the analytics team, such as written or video descriptions of the dashboard (e.g., training content for new users, analysis, etc.). The content may include a certification status of one or more users associated with the dashboard (e.g., a stakeholder or analytics team member). In certain examples, the content can include previous work tickets representing service requests to the analytics team generated by the user or other users of the dashboard.

In some examples, the content includes asset usage data (e.g., collected via the application extension 106 or the workstream application 110), net promoter scores (NPS), asset reviews, an asset lifecycle status (e.g., in-development, active, expiring, archived, etc.), and/or indicators of asset quality (e.g., is the underlying data or query broken).

In one example, the workstream application 110 can link an active (or live) content source to the data asset key. For example, the workstream application 110 may link an active messaging thread (e.g., Slack thread, chat thread, video conference, etc.) to the data asset key. The active content source can be linked to enable a live discussion related to the dashboard between the user and the analytics team. In certain examples, the workstream application 110 can be configured to link existing active content sources (e.g., conversations) and to create or generate new active content sources. In some examples, the active content sources are linked to the data asset key by requesting a reply to a system email (or other message type) from at least one user.

The workstream application 110 can be configured to apply rules to the active content source being linked. For example, the workstream application 110 may be configured to add users who have specific permissions to view (or modify) the dashboard. In some examples, the workstream application 110 may dynamically add users to the active content source by request (e.g., “@User1”). In other examples, the workstream application 110 may add users to the active content source who are included in a work ticket or otherwise associated with the dashboard.

The workstream application 110 can be connected to a user's (or customer's) data warehouse to layer data quality and data freshness metrics on top of the active or archived content. One or more configured tests may display a corresponding “Pass” or “Fail” indicator allowing the analyst or stakeholder to quickly determine what the issue is. In some examples, the analytics team can configure alerting thresholds to proactively monitor their ecosystem. This information is linked to an asset in the workstream application 110 leveraging the data asset key which allows it to be rendered both in the live dashboard or within the workstream application 110. As stakeholders and analysts navigate their AA ecosystem, the application extension 106 may auto-capture dashboards for supported AA platforms allowing the analyst the ability to view how the dashboard changed over its lifetime. In some examples, additional metadata is also captured providing more usage context to the analyst and/or user. For example, who viewed it, the date it was viewed, how long they viewed it for, etc.

In some examples, AA platform dashboards can be complex having multiple tabs or views. Using asset metadata, the data asset key can associate content to specific dashboard views allowing analysts to curate content at a more granular level. Conversations, image captures, and other data related to the dashboard can be associated as well.

At block 214, in response to a determination that the data asset key does not exist, the workstream application 110 checks for authorization to automatically add the data asset key to one or more databases. If authorization is approved, the workstream application 110 adds the data asset key to the user's workspace (block 216) and returns any content relevant to the data asset key (block 212). For example, the workstream application 110 may return application data that is associated with similar dashboards, the underlying data model, or the data set. Likewise, the workstream application 110 may link an existing active content source or generate a new active content source to the data asset key to enable a live discussion related to the dashboard. In one example, the workstream application 110 provides the archived content and the active content from the active content source to the application extension 106. If authorization is not approved, the workstream application 110 returns an error to the application extension 106 (block 218). The application extension 106 may prompt the user to add (or approve) the data asset key (block 220).

At block 222, the application extension 106 displays the archived content and the active content alongside the dashboard (e.g., within the browser). In some examples, the application extension 106 may graphically integrate the content within the AA platform 104; however, in other examples, the application extension 106 may open a new browser window (or tab) to display the content alongside the dashboard.

In addition to integrating content in AA platforms via the application extension 106, similar content may be integrated and displayed to the user via the workstream application 110. For example, at block 252, a user (e.g., stakeholder) views a dashboard in a user interface 150 of the workstream application 110. The workstream application 110 may generate a data asset key based on the dashboard.

At block 254, the workstream application 110 queries one or more databases to determine if the data asset key already exists in the workspace. At block 256, the workstream application 110 analyzes the query results to determine if the data asset key already exists in the workspace

At block 258, in response to a determination that the data asset key does already exist, the workstream application 110 returns application data (or content) associated with the data asset key. Likewise, the workstream application 110 may link an active (or live) content source to the data asset key. In one example, the workstream application 110 is configured to display the application data and the active content alongside the dashboard in the user interface 150 of the workstream application 110 (block 260). In some examples, the workstream application 110 may graphically integrate the content within the dashboard; however, in other examples, the workstream application 110 may open a new application window (or tab) to display the content alongside the dashboard. At block 262, in response to a determination that the data asset key does not exist, the workstream application 110 may return an error.

By integrating the analytical workstream content with the presentation assets, users can receive support and guidance from the analytics team without having to switch between several applications or tools. In other words, conversations and work the analytics team is performing can be presented to the user on top of the asset in real time. As such, the efficiency of the user and the analytics team can be improved. In addition, the likelihood of miscommunication errors between users and the analytics team (or between team members) can be reduced. In some examples, the integrated messaging content can be used to field user-generated requests or questions and may reduce the turnaround time for communicating solutions back to the users. Likewise, the integrated messaging content can enable stakeholders to answer questions from the analytics team. In certain examples, the integrated messaging content can include comments, annotations on the dashboard, and live or recorded video. For example, the user may annotate directly on the dashboard to provide feedback to the analytics team.

In some examples, the integrated content can be used to trigger automation or workflow within the workstream application 110 (or the AA platform 104). For example, while viewing a dashboard marked as “archived,” a stakeholder may send a request (or message) for the dashboard to be reactivated. The analytics team can receive the request and may communicate with the stakeholder to confirm the request. Once confirmed, the analytics team can grant the request via the workstream application 110 or the application extension 106. In some examples, once the dashboard status has been changed, the workstream application 110 may be configured to automatically move the dashboard from an archived folder to an active folder within the application 110 (or within the AA platform 104). Likewise, the stakeholder or analytics team may use the integrated content to mark a dashboard as “archived” and the workstream application 110 or the application extension may be configured to automatically move the dashboard to the archived folder (or to delete the dashboard).

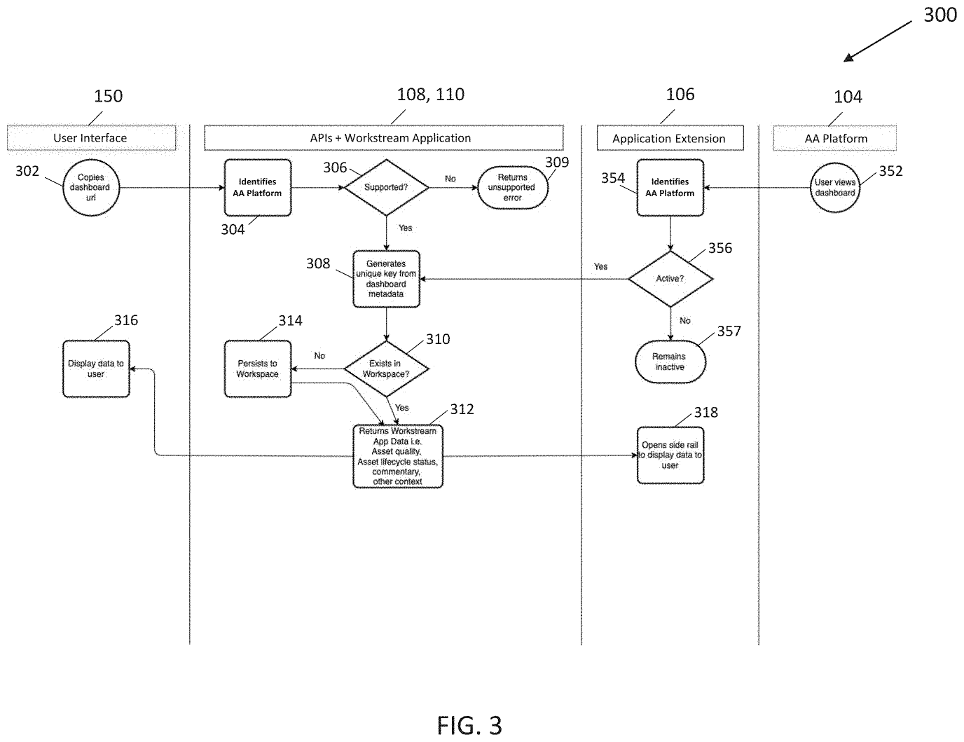

FIG. 3 is a flow diagram of a method 300 for adding a presentation asset to the workstream application 110 in accordance with aspects described herein. In one example, the method of FIG. 3 enables users to associate a presentation asset (e.g., a dashboard) to the workstream application 110 such that the dashboard can be viewed alongside the application data and active content. In some examples, the method 300 corresponds to an operation or process carried out by the workstream system 100 of FIG. 1.

At block 302, the method 300 begins when a user (i.e., data analyst) copies a URL of a dashboard from an AA platform 104. At block 304, once the URL is provided (e.g., pasted) into the workstream application 110, the workstream application 100 identifies the AA platform 104. At block 306, the workstream application 110 determines if the AA platform 104 is supported. At block 308, in response to a determination that the AA platform 104 is supported, the workstream application 110 generates a data asset key representative of the dashboard. The data asset key is assigned to the dashboard for future reference/lookups (e.g., as described in the method 200 of FIG. 2). In one example, the data asset key corresponds to an embedded URL that is different from the dashboard URL. In response to a determination that the AA platform 104 is not supported, the workstream application 110 may return an error (block 309).

At block 310, the workstream application 100 queries one or more databases to determine if the data asset key already exists in the user's workspace. In some examples, the data asset key may already exist if the dashboard has been previously linked to the workstream application 110. For example, the data asset key may have been generated during a setup or configuration of the dashboard and/or the workstream application 110.

At block 310, the workstream application 110 analyzes the query results to determine if the already exists in the user's workspace. At block 312, in response to a determination that the data asset key does already exist, the workstream application 110 returns application data (or content) associated with the data asset key. In some examples, the application content includes archived content. For example, the workstream application 110 may return archived messaging content including conversations (e.g., email threads, Slack messages, recorded video conferences, etc.) that occurred in the past and are relevant to the dashboard. The archived messaging content can include prior conversations held between the user and the analytics team, prior conversations held between a different user and the analytics team, and prior conversations held between different members of the analytics team. In addition, the content may include annotations indicating changes or updates to the dashboard, the underlying data model, or the data set. In certain examples, the content can include previous work tickets representing service requests to the analytics team generated by the user or other users of the dashboard.

In some examples, the content may include asset usage data (e.g., collected via the application extension 106 or the workstream application 110), net promoter scores (NPS), asset reviews, an asset lifecycle status (e.g., in-development, active, expiring, archived, etc.), and/or indicators of asset quality (e.g., is the underlying data or query broken).

In one example, the workstream application 110 may link an active (or live) content source to the data asset key. For example, the workstream application 110 may link an active messaging thread (e.g., Slack thread, chat thread, etc.) to the data asset key. The active content source can be linked to enable a live discussion related to the dashboard between the user and the analytics team. In certain examples, the workstream application 110 may be configured to link existing active content sources (e.g., conversations) and to create or generate new active content sources.

At block 314, in response to a determination that the data asset key does not exist, the workstream application 110 may add the data asset key to one or more databases. In some examples, the workstream application may add the data asset key to the user's workspace (block 314) and return any content relevant to the data asset key (block 312). For example, the workstream application 110 may retrieve content that is associated with similar dashboards, the underlying data model, or the data set. Likewise, the workstream application 110 may link (or create) an active content source to enable a live discussion related to the dashboard.

At block 316, the workstream application 110 is configured to display the application data and the active content alongside the dashboard in the user interface 150 of the workstream application 110. In some examples, the workstream application 110 may graphically integrate the content within the dashboard; however, in other examples, the workstream application 110 may open a new application window (or tab) to display the content alongside the dashboard. In addition, the workstream application 110 may provide the application data and active content from the active content source to the application extension 106 (block 318). The application extension 106 can display the archived content and the active content alongside the dashboard in the browser. In some examples, the application extension 106 may graphically integrate the content within the AA platform 104; however, in other examples, the application extension 106 may open a new browser window (or tab) to display the content alongside the dashboard.

In certain examples, the application extension 106 includes an “auto-add” function that enables users to add new dashboards to the workstream application 110 directly from the browser. For example, at block 352, a user (e.g.., a data analyst) views a dashboard in a browser-based AA platform 104. The user may select the “auto-add” function in the application extension 106. At block 354, the application extension 106 identifies the AA platform 104. At block 356, the application extension 106 determines if the AA platform 104 is active. In response to a determination that the AA platform 104 is active, the application extension 106 provides information (e.g., metadata) corresponding to the dashboard to the workstream application 110. The workstream application 110 generates a data asset key for the dashboard based on the metadata provided from the application extension 106, returns application data and active content associated with the data asset key, and integrates the application data and the active content with the dashboard as described above in blocks 308-318. The application extension 106 may remain inactive in response to a determination that the AA platform 104 is inactive (block 357).

While the method 300 describes adding a single presentation asset to the workstream application 110, it should be appreciated that multiple assets may be added at once (e.g., “en masse”). For example, the user may connect their workstream workspace (e.g., within the workstream application 110) to one or more tools (e.g., Looker) at the API level. The API(s) will pull the information necessary to generate the unique identifiers (e.g., data asset keys) that can be used to identify relevant assets and content.

While the examples above are described with reference to AA platforms, it should be appreciated that the systems and methods provided herein can be configured to support different types of data products. For example, the application extension 106 may be configured to support business intelligence tools, general productivity tools, operational software-as-a-service (SaaS) tools, data transformation tools, collaboration tools, communication tools, multimedia tools, agile project management tools, security tools, identify management tools, spreadsheets, data dumps, lightweight apps including scripts for linking data warehouses (or AA instances), and other types of data products. In some examples, the application extension 106 may be configured to support any data asset or product that is capable of being programmatically managed. As such, the application extension 106 can be configured to integrate analytical workstream content with various types of data products.

As described above, improved systems and methods for integrating analytical workstream content with presentation assets are provided herein. In at least one embodiment, an application extension is configured to integrate messaging content with presentation assets included in an analytical asset platform. In some examples, the application extension displays active messaging content and archived messaging content alongside the presentation assets.

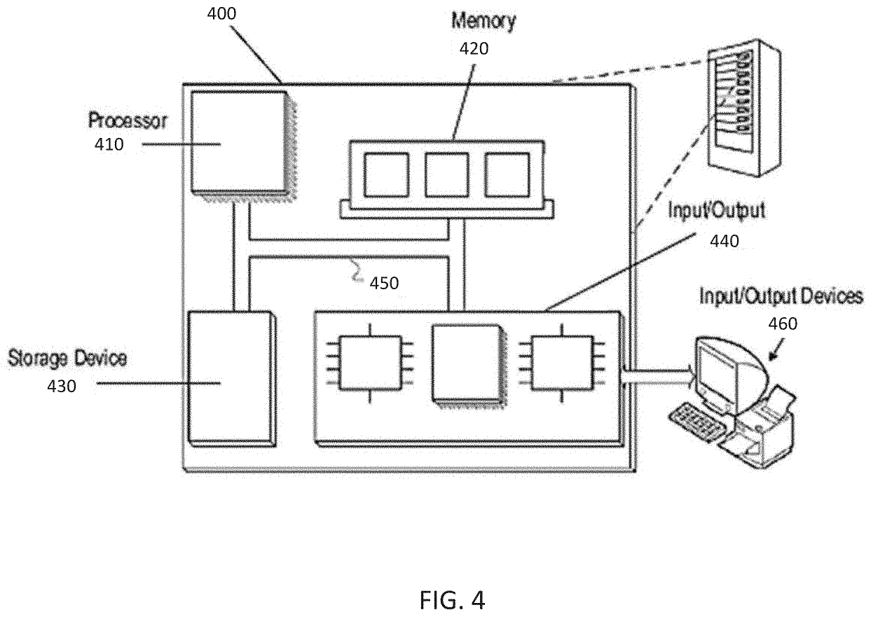

FIG. 4 is a block diagram of an example computer system 400 that may be used in implementing the systems and methods described herein. General-purpose computers, network appliances, mobile devices, or other electronic systems may also include at least portions of the system 400. The system 400 includes a processor 410, a memory 420, a storage device 430, and an input/output device 440. Each of the components 410, 420, 430, and 440 may be interconnected, for example, using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430.

The memory 420 stores information within the system 400. In some implementations, the memory 420 is a non-transitory computer-readable medium. In some implementations, the memory 420 is a volatile memory unit. In some implementations, the memory 420 is a non-volatile memory unit. In some examples, some or all of the data described above can be stored on a personal computing device, in data storage hosted on one or more centralized computing devices, or via cloud-based storage. In some examples, some data is stored in one location and other data is stored in another location. In some examples, quantum computing can be used. In some examples, functional programming languages can be used. In some examples, electrical memory, such as flash-based memory, can be used.

The storage device 430 is capable of providing mass storage for the system 400. In some implementations, the storage device 430 is a non-transitory computer-readable medium. In various different implementations, the storage device 430 may include, for example, a hard disk device, an optical disk device, a solid-date drive, a flash drive, or some other large capacity storage device. For example, the storage device may store long-term data (e.g., database data, file system data, etc.). The input/output device 440 provides input/output operations for the system 400. In some implementations, the input/output device 440 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 460. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 430 may be implemented in a distributed over a network, such as a server farm or a set of widely distributed servers, or may be implemented in a single computing device.

Although an example processing system has been described in FIG. 4, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for integrating messaging content and presentation assets, the method comprising:
identifying, via a browser extension operating within a browser application, a presentation asset being viewed within the browser application and metadata corresponding to the presentation asset;
generating a data asset key based on the metadata;
assigning the data asset key to an active messaging content source;
querying a database to retrieve archived messaging content associated with the data asset key; and
displaying, in the browser application via the browser extension, messaging content from the active messaging content source and/or the archived messaging content alongside the presentation asset.

2. The method of claim 1, wherein displaying the messaging content alongside the presentation asset includes graphically integrating the messaging content within a browser window with the presentation asset.

3. The method of claim 1, wherein displaying the messaging content alongside the presentation asset includes automatically opening a browser window of the browser application to display the messaging content.

4. The method of claim 3, wherein the presentation asset is displayed in a first browser window and the messaging content is displayed in a second browser window, the first and second browser windows being different browser windows of the browser application.

5. The method of claim 1, wherein identifying the metadata corresponding to the presentation asset includes inspecting a uniform resource locator (URL) of the presentation asset.

6. The method of claim 1, wherein assigning the data asset key to the active messaging content source includes generating the active messaging content source.

7. The method of claim 1, wherein the archived messaging content includes at least one of a messaging thread associated with the presentation asset, a screenshot associated with the presentation asset, and a video message associated with the presentation asset.

8. The method of claim 1, wherein the presentation asset includes a visual representation of a data asset.

9. The method of claim 1, wherein the presentation asset includes an interactive dashboard representing a data asset.

10. The method of claim 1, further comprising:
dynamically updating the displayed messaging content from the active messaging content source.

11. A system, comprising:
at least one memory; and
at least one processing unit for executing computer-executable instructions stored in the memory, wherein the instructions, when executed, instruct the at least one processing unit to:
identify, via a browser extension operating within a browser application, a presentation asset being viewed within the browser application and metadata corresponding to the presentation asset;
generate a data asset key based on the metadata;
assign the data asset key to an active messaging content source;
query a database to retrieve archived messaging content associated with the data asset key; and
display, in the browser application via the browser extension, messaging content from the active messaging content source and the archived messaging content alongside the presentation asset.

12. The system of claim 11, wherein displaying messaging content from the active messaging content source and the archived messaging content alongside the presentation asset includes graphically integrating the active and archived messaging content within a browser window with the presentation asset.

13. The system of claim 11, wherein displaying the messaging content alongside the presentation asset includes automatically opening a browser window of the browser application to display the messaging content.

14. The system of claim 13, wherein the presentation asset is displayed in a first browser window and the messaging content is displayed in a second browser window, the first and second browser windows being different browser windows of the browser application.

15. The system of claim 11, wherein identifying the metadata corresponding to the presentation asset includes inspecting a uniform resource locator (URL) of the presentation asset.

16. The system of claim 11, wherein assigning the data asset key to the active messaging content source includes generating the active messaging content source.

17. The system of claim 11, wherein the archived messaging content includes at least one of a messaging thread associated with the presentation asset, a screenshot associated with the presentation asset, and a video message associated with the presentation asset.

18. The system of claim 11, wherein the presentation asset includes a visual representation of a data asset.

19. The system of claim 11, wherein the presentation asset includes an interactive dashboard representing a data asset.

20. The system of claim 11, wherein the instructions, when executed, further instruct the at least one processing unit to:
dynamically update the displayed messaging content from the active messaging content source.
